(19) United States
(12) Patent Application Publication
(10) Pub. No.: US 2015/0110920 A1
(43) Pub. Date: Apr. 23, 2015

(54) PROCESS FOR THE PREPARATION OF CHEESE

(71) Applicants: Timothy John Armstrong, Paso, WA (US); Aileen Kacvinsky, Blanchard, MI (US); Willard R. Knoespel, Green Bay, WI (US); Dirk Kuckelsberg, Bredstedt (DE); Thomas Michael Rouleau, Granger, WA (US)

(72) Inventors: Timothy John Armstrong, Paso, WA (US); Aileen Kacvinsky, Blanchard, MI (US); Willard R. Knoespel, Green Bay, WI (US); Dirk Kuckelsberg, Bredstedt (DE); Thomas Michael Rouleau, Granger, WA (US)

(21) Appl. No.: 14/395,314

(22) PCT Filed: Apr. 18, 2013
(86) PCT No.: PCT/EP2013/058092

§ 371 Date: Oct. 17, 2014

Related U.S. Application Data
(60) Provisional application No. 61/635,439, filed on Apr. 19, 2012.

(51) Int. Cl. A23C 19/04; A23C 19/045; A23C 19/072

(52) U.S. Cl. CPC A23C 19/041; A23C 19/072; A23C 19/045
USPC 426/39; 426/582

(57) ABSTRACT

The present invention provides a process for the preparation of a cheese, the process comprising the steps of
(i) providing milk;
(ii) acidifying the milk, wherein the milk is acidified with carbon dioxide to a pH of 6.2 to 6.6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

### FIELD OF THE INVENTION

The present invention relates to a process for preparing a cheese and to a cheese prepared by that process.

### BACKGROUND TO THE INVENTION

Hotchkiss et al, Addition Of Carbon Dioxide To Dairy Products To Improve Quality: A Comprehensive Review, Comprehensive Reviews In Food Science And Food Safety—Vol. 5, 2006, 158-168, provides a review of the use of carbon dioxide in dairy products. In particular, in respect of cheese manufacture it refers to ‘The effect of CO2 treatment of raw milk intended for manufacturing cheese has been investigated. Calvo and others (1993) found that acidification of raw milk with CO2 to pH between 6.0 and 6.5 reduced psychrotrophic bacteria counts, resulting in improved cheese yields. However, the differences were small and the initial microbial counts were in the range of 10⁵ to 10⁷ cfu mL⁻¹ in the controls. Other studies (Ruas-Madiedo, Alonso, and others 1998; Ruas-Madiedo, Bada Gancedo, and others 1998) looked at milk of lower microbial load and found that cheese yields from CO2-treated and -untreated stored milk did not differ significantly. In poor quality milk, however, yield of the control milk was significantly less than yield achieved in the CO2-treated milk. In this study, CO2 was removed prior to cheese making, and the cheese was acid coagulated. McCarney and others (1995) have also investigated the effects of CO2 addition to milk used to make cheese. They concluded that the addition of 30 mM of CO2 reduced the time to reach psychrotrophic counts of 10⁶ cfu mL⁻¹ and that this in turn improved grading scores. The cheese made from CO2-treated milk showed fewer products of casein and lipid breakdown, presumably due to reduced proteolytic and lipolytic activity. Montilla and others (1995) showed a 75% reduction in the amount of rennet necessary for coagulation along with a small reduction in proteolysis in cheeses made with CO2-treated milk. There was no significant difference in the organoleptic properties of the cheeses. The authors suggested that use of CO2-treated milk would not have detrimental effects on cheese properties or yield and would extend the keeping quality of the raw milk. In a later study, Ruas-Madiedo and others (2002) examined the effect of CO2 addition to raw milk on the manufacture of rennet-coagulated Spanish hard cheeses, both made from pasteurized milk and aged for 30 days and from a 90:10 mixture of raw milk from cows and ewes and aged 75 days, CO2 was removed from raw milk prior to pasteurization and/or the cheese-making process. Compared to cheese made with pasteurized milk, CO2-treated milk showed slower initial growth of lactic acid bacteria with lower levels of acids. Compared to cheeses made from unpasteurized milk, both CO2-treated cheeses exhibited no change in volatile compound production, a reduction in clotting time, a higher cheese yield, and an increase in cheese hardness. In a later study (Ruas-Madiedo and others 2003) the group extended this work by examining the effects of the treatments on proteolysis. Cheeses made from CO2-treated milk exhibited lower amounts of hydrophilic peptides and no change in hydrophobic peptides at the end of ripening. β-casein breakdown was not affected while αs1-casein breakdown was enhanced during aging; no difference in taste was detected, as measured by a sensory panel. Nelson and others (2004a, 2004b) similarly found no change in β-casein breakdown and an increase in α-casein breakdown during the aging of cheese made with CO2-treated milk. In this study, however, milk was preacidified with 35 mM CO2, which was not removed prior to cheese making. A significant reduction in make time was observed compared to the control milk cheese. Cheese manufactured from CO2-acidified milk had less total fat and calcium than the control cheese, and higher total salts, while total crude protein did not change. During aging, the use of starter and coagulant cultures was the same for both treated and untreated milks; however, proteolysis was found to be higher in the CO2 treated cheese.’

U.S. Pat. No. 6,458,393 provides teaching in respect of cottage cheese. In particular, U.S. Pat. No. 6,458,393 teaches ‘cottage cheese is a soft, mild acid-coagulated uncured cheese made primarily from a milk source. Cottage cheese is made up of relatively small pieces or particles of cottage cheese curd which are suspended in, or blended with, a creamy dressing. In a conventional manufacturing process, a milk source (i.e., full fat, reduced fat, or skim milk depending on the level of fat desired) is pasteurized and homogenized. After cooling, the milk source is inoculated with conventional lactic acid-generating culture. Rennet may also be used to aid the coagulation. The mixture is typically held at the inoculation temperature until it has ripened and a coagulum is formed. The acidity of the coagulum is from about 0.7% to about 1% (calculated as percent equivalent lactic acid). After the coagulum has been formed and the desired acidity is obtained, the curd is cut into small pieces with agitation. The cut curd is heated to about 120 to about 130° F. and held at that temperature for about 100 to about 140 minutes. The curds are then separated from the whey. The curds are then suspended in, or blended into, a creamy dressing to form the cottage cheese product. The resulting cottage cheese product is then normally dispensed into retail containers and then refrigerated. Low-fat and fat-free cottage cheeses are known in the art to provide substantial amounts of protein to the consumer with an accompanying low level of fat, and thus is a desirable source of protein in many health-conscious individuals diet. Such consumers generally prefer a creamy product in which the curds and dressing are blended together. In other words, consumers prefer cottage cheeses in which the curds do not appear to be “swimming” in the dressing. Such “swimming” effect is often observed when the curds and dressing tend to separate in the container. The curds and dressing can be mixed prior to serving to at least alleviate the problem; in many cases, however, such mixing can not significantly overcome the problem. It would be desirable, therefore, if cottage cheese could be produced in which the separation or “swimming” problem is eliminated or at least substantially reduced.’

U.S. Pat. No. 6,458,393 in particular teaches a cottage cheese having a more porous cottage cheese curd and methods for making such cottage cheese. The cottage cheese products are said to be less likely to separate into separate phases (i.e., where the curds are said to “swim” in the dressing) and said to have significantly lower densities than conventional cottage cheese. U.S. Pat. No. 6,458,393 teaches a process for preparing a cottage cheese product having porous cottage cheese curd, said process comprising (1) preparing a cottage cheese dressing at a pH of about 5.6 to about 6.0; (2) preparing a porous cottage cheese curd at a pH of about 4.0 to about 4.8, wherein the porous cottage cheese curd is prepared in a fermentation mixture using a gas source to provide a gas to the fermentation mixture during the formation of the curd, whereby the gas forms pores within the curd; and (3) blending the cottage cheese dressing and the porous cottage cheese curd together to form the improved cottage cheese product.

EP1946647 (and EP2301365) relates to a low fat cheese. EP1946647 teaches that ‘consumer awareness of the caloric content of food has increased considerably over the past few years and has brought about a demand for foods having a reduced fat content. The cheese industry is no different. However, a general problem in low-fat cheeses is the occurrence of detrimental effects in cheese texture. The fat contributes to the lubrication and creamy mouth feel. Further, it occupies space in the protein matrix thereby preventing the formation of a dense matrix which would result in a hard and/or gummy cheese. Substantial efforts have been mounted to prepare a low-fat cheese exhibiting the appropriate texture, as well as having the good flavour associated with its conventional fat-containing counterpart. In general, various approaches can be followed, e.g. use of exopolysaccharide (EPS) capsular polysaccharide (CPS) producing strains, fat replacers and whey protein concentrates (WPC). Despite all attempts to replace as much of the fat content of a semi-hard or hard cheese as possible, the success rate has been fairly limited.’EP1946647 more particularly teaches a low-fat cheese of the semi-hard type having textural properties which are said to closely resemble that of its normal fat-containing counterpart, and which cheese is said not exhibit the rubber-like characteristics often associated with such low-fat cheese. Specifically there is taught ‘a process for preparing a semi-hard cheese having a reduced fat content, wherein the process involves the steps of: (a) providing milk, of which at least a part is skim milk; (b) acidifying said milk to a pH in the range of 5.5-6.5; and/or providing said milk with a calcium complexing agent; and (c) subsequent setting and scalding, wherein the temperature during scalding is maintained between 28 and 32° C., and wherein the process further involves curd washing, to obtain a semi-hard cheese having pH>5.2 after 4 weeks of subsequent ripening. The acidification may e.g. be achieved by means of a starter, organic/inorganic acid, for instance hydrochloric acid, glucono-delta-lactone, citric acid, or CO₂ flushing, or combinations thereof. However, the invention is not considered to be limited hereto.’

WO2007027926 and WO2007027953 teach production of mozzarella and cheddar, respectively. WO2007027926 teaches that ‘most methods for making mozzarella cheese, especially those for making shredded mozzarella used on many food products, require about three days and involve about nine processing steps. In general, these processing steps include: making curds in a vat, separating the curds from the whey, cooking and stretching the curds, forming the stretched curds into a ball or block, packaging the cheese ball/block, cooling the cheese ballblock, allowing the cheese to rest for several days, dicing or shredding the cheese and freezing the diced/shredded cheese for use in food products. Some mozzarella cheese-making processes also include a step where the newly formed cheese ballblock is placed in brine. Thus, mozzarella cheese production involves a number of processing steps. Special equipment is generally used in large-scale mozzarella cheese-making facilities. Such equipment can include vats, strainers, cookers and stretchers, molders, presses, aging environments, shredders, dicers and packaging devices. Significant saving could be realized if mozzarella cheese could efficiently be made without some of these processing steps and types of equipment. Simpler, more efficient methods for making mozzarella cheese are therefore needed.’ WO2007027926 teaches a method in which controlling the pH of the cheese making process is performed to optimize the partitioning of minerals and proteins between curd and whey, and between the matrix and water phase within curd particles. In particular WO2007027926 discloses a method for making mozzarella cheese that includes reducing the pH of pasteurized milk used for making the cheese to a pH of about 5.6 to about 6.2, before adding cheese-making starter cultures. It is taught that the milk can be acidified with any acceptable food acidifying agent, and that use of carbon dioxide is generally preferred. WO2007027953 provides further details on cheddar cheese and in particular ‘in the United States, Cheddar cheese was traditionally produced in 18 kg (40 lb) blocks. In a highly cost-competitive market, more automated and efficient means of handling large quantities of cheese in rapidly expanding cheese factories were developed to control costs. Thus, in the late 1970s and early 1980s, the first 290 kg (640 lb) block Cheddar production lines were put into production. One 290 kg block replaced sixteen 18 kg blocks. The 290 kg block system reduced labor and handling costs, on-the-job lifting injuries, intermediate packaging costs, and trim loss when blocks were converted to the exact weight pieces needed for retail marketing. However, although the handling of 290 kg blocks of cheese with forklifts was efficient and easy, the cooling of the cheese in these large blocks immediately after manufacture was more difficult. Thus, as the 290 kg block systems became common in the industry, it became apparent that the cheese within the 290 kg blocks had variations in both composition and cheese quality. For example, in 1988, Reinbold et al. (J. Dairy Sci. 71: 1499-1506) observed that after 7 days of cooling a 290 kg block of cheese, moisture had travelled from areas of high to low temperature. Reinbold et al. also observed that after 24 hours of cooling, the curd had not completely fused and was still porous. Barbano et al. conducted systemic studies on 290 kg blocks of cheese and observed that a moisture gradient of about 5% existed from the inside to the outside of the cheese block. J. AOAC Intl. 84: 613-19 (2001). Thus the center of 290 kg blocks of cheese was significantly drier than the outside. Moisture was apparently wicking from the interior to the exterior during cooling of the cheese blocks, leading to irregularities and non-uniformities in cheese composition and quality. Smaller portions of cheese cut for retail sale from these 290 kg blocks were sometimes too wet, or too dry, depending upon what part of the block the retail portion was taken.’ WO2007027953 addresses these problems by providing a process for producing cheddar that includes reducing the pH of pasteurized milk used for making the cheese to a pH of about 5.6 to about 6.2, before adding cheese-making starter cultures. It is taught that the milk can be acidified with any acceptable food acidifying agent, and that use of carbon dioxide is generally preferred.

The use of carbon dioxide for acidifying milk for use in the production of cheddar cheese is further referred to by St-Gelais et al, Milchwissenschaft, 52 (11), 1997, 614-618. U.S. Pat. No. 6,258,391 provides a further disclosure relating to such cheeses. U.S. Pat. No. 6,258,391 relates inter alia the treatment of cheese milk with high pressure CO₂, which is said to accelerate the precipitation of casein from cheese milk without adverse affecting the rennet or starter culture.

Further references to on the use of carbon dioxide to acidify milk prior to cheese production are provided in Montilla et al, ‘Manufacture of Cheese made from CO₂ treated milk’, Z Lebensm Unters Forsch (1995) 200; 289-292; Nelson et al, ‘Impact of Milk Preacidifcation with CO₂ on the Aging and Proteolysis of Cheddar Cheese’, J Dairy Sci 87:3590-3600 and Osl et al ‘Zusatz von CO₂ bei Schnitt-und Hartkase’ Das dmz-Them 25/2001, 1060-1065.

### SUMMARY OF THE INVENTION

In a first aspect, there is provided a process for the preparation of a cheese, the process comprising the steps of
(i) providing milk;
(ii) acidifying the milk, wherein the milk is acidified with carbon dioxide to a pH of 6.2 to 6.6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

In a second aspect, there is provided a cheese obtainable by a process comprising the steps of
(i) providing milk;
(ii) acidifying the milk, wherein the milk is acidified with carbon dioxide to a pH of 6,2 to 6,6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

In a third aspect, there is provided a cheese prepared by a process comprising the steps of
(i) providing milk;
(ii) acidifying the milk, wherein the milk is acidified with carbon dioxide to a pH of 6.2 to 6.6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

In a further aspect, there is provided a process for the preparation of a cheese, the process comprising the steps of
(i) contacting milk comprising at least one coagulant, wherein the coagulant comprises at least a microbial protease coagulating agent with a sufficient quantity of carbon dioxide for a time sufficient to acidify the milk to a pH of about 6.2 to about 6.6 when measured at a temperature of 29 to 38° C. to provide an acidified milk;
(ii) adding at least one starter culture to the acidified milk by direct vat inoculation.

In a further aspect, there is provided a process for the preparation of a cheese, the process comprising the steps of
(i) providing milk;
(ii) acidifying the milk, wherein the milk is acidified with carbon dioxide to a pH of 6.2 to 6.6 to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

In a further aspect, there is provided a cheese obtainable by a process comprising the steps of
(i) providing milk;
(ii) acidifying the milk, wherein the milk is acidified with carbon dioxide to a pH of 6.2 to 6.6 to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

In a further third aspect, there is provided a cheese prepared by a process comprising the steps of
(i) providing milk;
(ii) acidifying the milk, wherein the milk is acidified with carbon dioxide to a pH of 6.2 to 6.6 to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

For ease of reference, these and further aspects of the present invention are now discussed under appropriate section headings. However, the teachings under each section are not necessarily limited to each particular section.

### ADVANTAGES

As is understood by one skilled in the art starter cultures are generally available from commercial manufacturers in lyophilized, frozen or liquid form. They can comprise only a single species of starter culture, such as a single lactic acid bacterium species, but can also be mixed cultures comprising two or more different species. Mixed starter cultures are often used to minimise bacteriophage infection.

Starter cultures can be inoculated directly into milk without intermediate transfer and/or propagation. Such starter cultures are generally referred to as direct vat set (DVS) or direct to vat inoculation (DVI) cultures. Despite the availability of DVS and DVI cultures, it is not uncommon that dairies produce in-house bulk starter cultures. Bulk starter cultures are made by inoculating a growth medium using a small amount of a starter culture followed by incubating the growth medium under conditions permitting the bacteria to propagate for a sufficient period of time to provide a desired cell number. The obtained bulk starter culture is then used to inoculate milk for the manufacture of fermented dairy products.

In commercial settings, we have found that conversion from a bulk starter system to a DVI (Direct Vat Inoculation) culture system has generally provided a pH acidification curve which is slower from the beginning of the inoculation. In particular, this conversion from one system (bulk starter) to another (DVI) and the resultant slower acidification curve can result in higher final pHs and higher final moistures. The variations can result in a final cheese which is sometimes out of specification. In addition, we have seen in commercial applications that the in-process whey fats can be increased 0.3 percentage points on average (from 0.5% to 0.8%) when using DVI vs. bulk starter. This results mainly from this increase in pH from the beginning of the process and may hinder coagulation efficiency. This has a direct impact on further processing of the whey (fat needs to be removed prior to further processing and higher whey fats can slow down this process) as well as a financial impact to the processing plant by losing this component (fat) in the cheese.

We have surprisingly found that in one aspect by providing a DVI system in which milk is acidified with carbon dioxide to a specific pH prior to preparing a cheese using a microbial protease coagulating agent, the DVI cultures can mimic bulk starter culture systems. In particular aspects, cheese having acceptable final moisture and pH levels can be provided. In some aspects, the whey fats levels provided by the present process are reduced to levels seen with bulk starter. We have found that we are able to prepare a cheese using a microbial protease coagulating agent in an amount less than, for example the prior art chymosin coagulating agents. This reduction in amount of coagulating agent is achieved without detriment to, for example, firmness, yield losses, and/or amount of fines in the whey.

### DETAILED DESCRIPTION

As discussed herein, the present invention provides a process for the preparation of a cheese, the process comprising the steps of
(i) providing milk;
(ii) acidifying the milk, wherein the milk is acidified with carbon dioxide to a pH of 6.2 to 6.6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

Cheese

The present process may be used to prepare any cheese. In one aspect the cheese is selected from Abbaye de Belloc, Abbaye de Citeaux, Abbaye du Mont des Cats, Abertam, Abondance, Acapella, Ackawi, Acorn, Adelost, Affidelice au Chablis, Afuega'l Pitu, Airag, Airedale, Aisy Cendre, Allgauer Emmentaler, Alverca, Ambert, American Cheese, Ami du Chambertin, Anejo Enchilado, Anneau du Vic-Bilh, Anthoriro, Appenzell, Aragon, Ardi Gasna, Ardrahan, Armenian String, Aromes au Gene de Marc, Asadero, Asiago, Aubisque Pyrenees, Autun, Avaxtskyr, Baby Swiss, Babybel, Baguette Laonnaise, Bakers, Baladi, Balaton, Bandal, Banon, Barry's Bay Cheddar, Basing, Basket Cheese, Bath Cheese, Bavarian Bergkase, Baylough, Beaufort, Beauvoorde, Beenleigh Blue, Beer Cheese, Bel Paese, Bergader, Bergere Bleue, Berkswell, Bethmale des Pyrénées, Bethmale of the Pyrenees, Beyaz Peynir, Bierkase, Bishop Kennedy, Blarney, Bleu d'Auvergne, Bleu de Gex, Bleu de Laqueuille, Bleu de Septmoncel, Bleu de Termignon Alpage, Bleu Des Causses, Blue, Blue Castello, Blue of Termignon, Blue Rathgore, Blue Vein (Australian), Blue Vein Cheeses, Bocconcini, Bocconcini (Australian), Boeren Leidenkaas, Bonchester, Bosworth, Bougon, Boule Du Roves, Boulette d'Avesnes, Boursault, Boursin, Bouyssou, Bra, Braudostur, Breakfast Cheese, Brebis du Lavort, Brebis du Lochois, Brebis du Puyfaucon, Bresse Bleu, Brick, Brie, Brie au poivre, Brie de Meaux, Brie de Melun, Brie with pepper, Brillat-Savarin, Brin, Brin d'Amour, Brin d'Amour, Brinza (Burduf Brinza), Briquette de Brebis, Briquette du Forez, Broccio, Broccio Demi-Affine, Brousse du Rove, Bruder Basil, Brusselae Kaas (Fromage de Bruxelles), Bryndza, Buchette d'Anjou, Buffalo, Burgos, Butte, Butterkase, Button (Innes), Buxton Blue, Cabecou, Caboc, Cabrales, Cachaille, Caciocavallo, Caciotta, Caerphilly, Cairnsmore, Calenzana, Cambazola, Camembert de Normandie, Canadian Cheddar, Canestrato, Centel, Caprice des Dieux, Capricorn Goat, Capriole Banon, Caravane, Carre de l'Est, Casciotta di Urbino, Cashel Blue, Castellano, Castelleno, Castelmagno, Castelo Branco, Castigliano, Cathelain, Celtic Promise, Cendre d'Olivet, Cerney, Chabichou, Chabichou du Poitou, Chabis de Gatine, Chaource, Charolais, Chaumes, Cheddar, Cheddar Clothbound, Cheshire, Chevres, Chevrotin des Aravis, Chontaleno, Civray, Coeur de Camembert au Calvados, Coeur de Chevre, Cojack, Colby, Colby-Jack, Cold Pack, Comte, Coolea, Cooleney, Coquetdale, Corleggy, Cornish Pepper, Cotherstone, Cotija, Cottage Cheese, Cottage Cheese (Australian), Cougar Gold, Coulommiers, Coverdale, Crayeux de Roncq, Cream Cheese, Cream Havarti, Crema Agria, Crema Mexicana, Creme Fraiche, Crescenza, Croghan, Crottin de Chavignol, Crottin du Chavignol, Crowdie, Crowley, Cuajada, Curd, Cure Nantais, Curworthy, Cwmtawe Pecorino, Cypress Grove Chevre, Danablu (Danish Blue), Denbo,

Danish Fontina, Daralagjazsky, Dauphin, Delice des Fiouves, Denhany Dorset Drum, Derby, Dessertnyj Belyj, Devon Blue, Devon Garland, Dolcelatte, Doolin, Doppelrhamstufel, Dorset Blue Vinney, Double Gloucester, Double Worcester, Dreux a la Feuille, Dry Jack, Duddleswell, Dunbarra, Dunlop, Dunsyre Blue, Duroblando, Durrus, Dutch Mimolette (Commissiekaas), Edam, Edelpilz, Emental Grand Cru, Emlett, Emmental, Epoisses de Bourgogne, Esbareich, Esrom, Etorki, Evansdale Farmhouse Brie, Evora De L'Alentejo, Exmoor Blue, Explorateur, Farmer, Feta, Feta (Australian), Figue, Filetta, Fin-de-Siecle, Finlandia Swiss, Finn, Fiore Sardo, Fleur du Maquis, Flor de Guia, Flower Marie, Folded, Folded cheese with mint, Fondant de Brebis, Fontainebleau, Fontal, Fontina Val d'Aosta, Formaggio di capra, Fougerus, Four Herb Gouda, Fourme d'Ambert, Fourme de Haute Loire, Fourme de Montbrison, Fresh Jack, Fresh Mozzarella, Fresh Ricotta, Fresh Truffles, Fribourgeois, Friesekaas, Friesian, Friesla, Frinault, Fromage a Raclette, Fromage Corse, Fromage de Montagne de Savoie, Fromage Frais, Fruit Cream Cheese, Frying Cheese, Fynbo, Gabriel, Galette du Paludier, Galette Lyonnaise, Galloway Goat's Milk Gems, Gammelost, Gaperon a l'Ail, Garrotxa, Gastanberra, Geitost, Gippsland Blue, Gjetost, Gloucester, Golden Cross, Gorgonzola, Gornyaltajski, Gospel Green, Gouda, Goutu, Gowrie, Grabetto, Graddost, Grafton Village Cheddar, Grana, Grana Padano, Grand Vatel, Grataron d'Areches, Gratte-Paille, Graviera, Greuilh, Greve, Gris de Lille, Gruyere, Gubbeen, Guerbigny, Halloumi, Halloumy (Australian), Haloumi-Style Cheese, Harbourne Blue, Havarti, Heidi Gruyere, Hereford Hop, Herrgardsost, Herriot Farmhouse, Nerve, Hipi Iti, Hubbardston Blue Cow, Humboldt Fog, Hushallsost, lberico, Idaho Goatster, Idiazabal, Il Boschetto al Tartufo, Ile d'Yeu, Isle of Mull, Jarlsberg, Jermi Tortes, Jibneh Arabieh, Jindi Brie, Jubilee Blue, Juustoleipa, Kadchgall, Kaseri, Kashta, Kefalotyri, Kenafa, Kernhem, Kervella Affine, Kikorangi, King Island Cape Wickham Brie, King River Gold, Klosterkaese, Knockalara, Kugelkase, L'Aveyronnais, L'Ecir de l'Aubrac, La Taupiniere, La Vache Qui Rit, Laguiole, Lairobell, Lajta, Lanark Blue, Lancashire, Langres, Lappi, Laruns, Lavistown, Le Brin, Le Fium Orbo, Le Lacandou, Le Roule, Leafield, Lebbene, Leerdammer, Leicester, Leyden, Limburger, Lincolnshire Poacher, Lingot Saint Bousquet d'Orb, Liptauer, Little Rydings, Livarot, Llanboidy, Llanglofan Farmhouse, Loch Arthur Farmhouse, Loddiswell Avondale, Longhorn, Lou Palou, Lou Fevre, Lyonnais, Maasdam, Macconais, Mahoe Aged Gouda, Mahon, Malvern, Mamirolle, Manchego, Manouri, Manur, Marble Cheddar, Marbled Cheeses, Maredsous, Margotin, Maribo, Maroilles, Mascares, Mascarpone, Mascarpone (Australian), Mascarpone Torte, Matocq, Maytag Blue, Metre, Menailack Farmhouse, Menonita, Meredith Blue, Mesost, Metton (Cancoillotte), Meyer Vintage Gouda, Mihalic Peynir, Milleens, Mimolette, Mine-Gabhar, Mini Baby Bells, Mixte, Molbo, Monastery Cheeses, Mondseer, Mont D'or Lyonnais, Montasio, Monterey Jack, Monterey Jack Dry, Morbier, Morbier Cru de Montagne, Mothais a la Feuille, Mozzarella, Mozzarella (Australian), Mozzarella di Bufala, Mozzarella Fresh, in water, Mozzarella Rolls, Muenster, Munster, Murol, Mycella, Myzithra, Naboulsi, Nantais, Neufchatel, Neufchatel (Australian), Niolo, Nokkelost, Northumberland, Oaxaca, Olde York, Olivet au Foin, Olivet Bleu, Olivet Cendre, Orkney Extra Mature Cheddar, Orla, Oschtjepka, Ossau Fermier, Ossau-Iraty, Oszczypek, Oxford Blue, P'tit Berrichon, Palet de Babligny, Paneer, Panela, Pannerone, Pant ys Gawn, Parmesan (Parmigiano), Parmigiano Reggiano, Pas de l'Escalette, Passendale, Pasteurized Processed, Pate de Fromage, Patefine Fort, Pave d'Affinois, Pave d'Auge, Pave de Chirac, Pave du Berry, Pecorino, Pecorino in Walnut Leaves, Pecorino Romano, Peekskill Pyramid, Pelardon des Cevennes, Pelardon des Corbieres, Penamellera, Penbryn, Pencarreg, Pepper jack, Perail de Brebis, Petit Morin, Petit Pardou, Petit-Suisse, Picodon de Chevre, Picos de Europa, Pinconning, Piora, Pithtviers au Foin, Plateau de Herve, Plymouth Cheese, Podhalanski, Poivre d'Ane, Polkolbin, Pont l'Eveque, Port Nicholson, Port-Salut, Postel, Pouligny-Saint-Pierre, Pourly, Prastost, Pressato, Prince-Jean, Processed Cheddar, Provel, Provolone, Provolone (Australian), Pyengana Cheddar, Pyramide, Quark, Quark (Australian), Quartirolo Lombardo, Quatre-Vents, Quercy Petit, Queso Blanco, Queso Blanco con Frutas—Pina y Mango, Queso de Murcia, Queso del Montsec, Queso del Tietar, Queso Fresco, Queso Fresco (Adobera), Queso Iberico, Queso Jalapeno, Queso Majorero, Queso Media Luna, Queso Para Frier, Queso Quesadilla, Rabacal, Raclette, Ragusano, Raschera, Reblochon, Red Leicester, Regal de la Dombes, Reggianito, Remedou, Requeson, Richelieu, Ricotta, Ricotta (Australian), Ricotta Salata, Ridder, Rigotte, Rocamadour, Rollot, Romano, Romans Part Dieu, Roncal, Roquefort, Roule, Rouleau De Beaulieu, Royalp Tilsit, Rubens, Rustinu, Saaland Pfarr, Saanenkaese, Saga, Sage Derby, Sainte Maure, Saint-Marcellin, Saint-Nectaire, Saint-Paulin, Salers, Samso, San Simon, Sancerre, Sap Sago, Sardo, Sardo Egyptian, Sbrinz, Scamorza, Schabzieger, Schloss, Selles sur Cher, Selva, Serat, Seriously Strong Cheddar, Serra da Estrela, Sharpam, Shelburne Cheddar, Shropshire Blue, Siraz, Sirene, Smoked Gouda, Somerset Brie, Sonoma Jack, Sottocenare al Tartufo, Soumaintrain, Sourire Lozerien, Spenwood, Sraffordshire Organic, St. Agur Blue Cheese, Stilton, Stinking Bishop, String, Sussex Slipcote, Sveciaost, Swaledale, Sweet Style Swiss, Swiss, Syrian (Armenian String), Tala, Taleggio, Tamie, Tasmania Highland Chevre Log, Taupiniere, Teifi, Telemea, Testouri, Tete de Moine, Tetilla, Texas Goat Cheese, Tibet, Tillamook Cheddar, Tilsit, Timboon Brie, Toma, Tomme Brulee, Tomme d'Abondance, Tomme de Chevre, Tomme de Romans, Tomme de Savoie, Tomme des Chouans, Tommes, Torte del Casar, Toscanello, Touree de L'Aubier, Tourmalet, Trappe (Veritable), Trois Comes De Vendee, Tronchon, Trou du Cru, Truffe, Tupi, Turunmaa, Tymsboro, Tyn Grug, Tyning, Ubriaco, Ulloa, Vacherin-Fribourgeois, Valencay, Vasterbottenost, Venaco, Vendomois, Vieux Corse, Vignotte, Vulscombe, Waimata Farmhouse Blue, Washed Rind Cheese (Australian), Waterloo, Weichkaese, Wellington, Wensleydale, White Stilton, Whitestone Farmhouse, Wigmore, Woodside Cabecou, Xynotyro, Yarg Cornish, Yarra Valley Pyramid, Yorkshire Blue, Zamorano, Zanetti Grana Padano, and Zanetti Parmigiano Reggiano. In another aspect the cheese is selected from mozzarella, cheddar, cottage cheese, parmesan, and ‘Swiss’ cheese. In another aspect the cheese is selected from semi-hard cheeses (such as continental cheeses and including gouda, edam, masdam), cheddar, cottage cheese, pasta filata cheese (such as mozzarella, pizza cheese), hard cheeses (such as parmesan, swiss type cheese, emmental type cheese), soft cheeses, Tvarog and lactic curd.

The milk used in the present process may be pasteurised or non-pasteurized (i.e. raw). In one aspect the milk is pasteurised milk. The milk may be standardised, homogenised or standardised and homogenised. It may also be the subject of one or more other treatments such ultra heat treatment (UHT).

The milk may be selected from, for example and without limitation, whole milk, reconstituted skim milk powder, skim milk, semi-skim milk and mixtures thereof.

The milk is obtained from any animal the milk of which is suitable for human consumption. Such animals include, for example and without limitation, cow, camel, donkey, goat, horse, reindeer, sheep, water buffalo, and yak. The milk may also be a mixture of milks from one or more of the above-mentioned animals. In some aspects, the milk is selected from cow milk, sheep milk, goat milk and combinations thereof. In one aspect the milk is cow milk.

Acidification

It is a feature of the present invention that the milk is acidified with carbon dioxide, such that the pH of the acidified milk is about 6.2 to about 6.6. The milk is acidified by contacting the milk with a sufficient amount of carbon dioxide for time sufficient to acidify the milk to the required pH. The carbon dioxide may be delivered to and contact with the milk in any suitable manner. For example, the milk may be acidified by the addition of solid carbon dioxide to the milk. The solid carbon dioxide may be added in the form of pellets or larger blocks such as dry ice. In addition or in an alternative, the milk may be acidified by the bubbling of gaseous carbon dioxide through the milk. This may be performed by use of a sparging unit or any other appropriate apparatus. The operation and use of such units for contacting gaseous carbon dioxide with a liquid is well understood by one skilled in the art.

It is a requirement of the present invention that the pH of the milk is reduced from its initial value to the required range of 6.2 to 6.6. This will typically be achieved solely by addition of carbon dioxide to the milk i.e. the milk is acidified solely with carbon dioxide. In some aspects, carbon dioxide is the only source of acid used to acidify the milk. In certain aspects, the milk is acidified in part with carbon dioxide and in part with a secondary acidifying agent. Suitable secondary acidifying agent may be identified by one skilled in the art and include culture, such a lactic acid bacteria culture, organic or inorganic acids, such as hydrochloric acid or citric acid, and combinations thereof.

In respect of the acidification with carbon dioxide, one skilled in the art may calculate by routine experimentation by measurement of pH and without undue burden the amount of carbon dioxide required to acidify a given sample of milk to the desired extent. One skilled in the art may calculate by routine experimentation the amount of carbon dioxide and/or secondary acidifying agent needed to reach the desired measurement of pH and without undue burden the amount of carbon dioxide required to acidify a given sample of milk to the desired extent by routine methods that are well understood by a person of ordinary skill. In some aspects, a pH probe may be used to measure the pH of the milk and determine when the milk has reached the desired pH, at which time the addition of carbon dioxide and/or secondary acidifying agent can be stopped. In one aspect the present process further comprises the step of measuring the pH of the milk of step (i), and adding carbon dioxide to the milk in amount required to provide acidified milk having a pH of 6.2 to 6.6 when measured at a temperature of 29 to 38° C., wherein the amount of carbon dioxide added is 90 grams [0.2 lbs] of carbon dioxide per 1000 lbs of milk per 0.08 unit pH reduction.

In particular aspects the milk is acidified with carbon dioxide to a pH of, for example, 6.3 to 6.6, 6.35 to 6.6, pH of 6.3 to 6.55, pH of 6.4 to 6.6, pH of 6.35 to 6.57, pH of 6.4 to 6.57, pH of 6.41 to 6.6, pH of 6.41 to 6.57, pH of 6.41, 6.44 or 6.57.

In particular aspects the milk is acidified with carbon dioxide to a pH of, for example, 6.3 to 6.6, 6.35 to 6.6, pH of 6.3 to 6.55, pH of 6.4 to 6.6, pH of 6.35 to 6.57, pH of 6.4 to 6.57, pH of 6.41 to 6.6, pH of 6.41 to 6.57, pH of 6.41, 6.44 or 6.57, when measured at a temperature of 29 to 38° C.

The temperature at which the pH is measured may be from 31 to 36° C., such as 33 to 35° C., preferably about 34° C.

Coagulant

As discussed herein the inoculated acidified milk from which the cheese is prepared contains a coagulant. The coagulant comprises at least a microbial protease coagulating agent. The microbial protease coagulating agent may be the sole coagulant, in other words the coagulant consists of or consists essentially of the microbial protease coagulating agent. However, in one aspect the coagulant comprises the microbial protease coagulating agent and a secondary coagulating agent. The secondary coagulating agent is selected from animal -based coagulants such as rennet, vegetable-based coagulants such as Ficine and Bromeline, microbial based coagulants such as fermented produced chymosin coagulant or proteases obtained from e.g. Mucor miehei or Mucor pusillus or Cryphonectria parasitica.

The microbial protease coagulating agent is preferably a single enzyme coagulating agent. However, combinations of enzymes are also envisaged.

In one aspect, the microbial protease coagulating agent has k-casein cleaving activity. In one aspect the microbial protease coagulating agent predominantly has k-casein cleaving activity (that is the k-casein cleaving activity is greater than any side activities). In one aspect the microbial protease coagulating agent solely has k-casein cleaving activity (that is the microbial protease coagulating agent has no significant side activities). In one aspect the microbial protease coagulating agent is k-casein specific cleaving enzyme.

In one aspect, the microbial protease coagulating agent has pepsin activity. In one aspect the microbial protease coagulating agent predominantly has pepsin activity (that is the pepsin activity is greater than any side activities). In one aspect the microbial protease coagulating agent solely has pepsin activity (that is the microbial protease coagulating agent has no significant side activities). In one aspect the microbial protease coagulating agent is a pepsin.

In one aspect, the microbial protease coagulating agent has mucorpepsin (EC 3.4.23.23) activity. In one aspect the microbial protease coagulating agent predominantly has mucorpepsin (EC 3.4.23.23) activity (that is the mucorpepsin (EC 3.4.23.23) activity is greater than any side activities). In one aspect the microbial protease coagulating agent solely has mucorpepsin (EC 3.4.23.23) activity (that is the microbial protease coagulating agent has no significant side activities). In one aspect the microbial protease coagulating agent is a mucorpepsin (EC 3.4.23,23).

In yet other aspects the microbial protease coagulating agent is a single enzyme coagulating agent consisting of a mucorpepsin (EC 3,4.23.23) having k-casein specific cleaving activity. In yet other aspects the microbial protease coagulating agent consists essentially of a mucorpepsin (EC 3.4,23.23) having k-casein specific cleaving activity. In further aspects the microbial protease coagulating agent is at least mucorpepsin (EC 3.4.23.23), such as MARZYME® available from Danisco A/S. Preferably the microbial protease coagulating agent consists of mucorpepsin (EC 3.4.23.23), such as MARZYME® available from Danisco A/S.

### EXAMPLES

The invention will now be described with reference to the following non-limiting example.

The history regarding conversion from bulk starter to DVI (Direct Vat Inoculation) culture system has shown that generally the pH acidification curve is slower from the beginning when converting to DVI culture systems from bulk starter and can result in higher end pHs and higher moistures (sometimes out of specification) because of this in-process condition. In addition, we have seen in commercial applications that the in-process whey fats can be increased 0.3% average (from 0.5% to 0.8%) when using DVI vs. bulk starter resulting mainly from this increase in pH from the beginning of the process, hindering coagulation efficiency. This has a direct impact on further processing of the whey (fat needs to be removed prior to further processing and higher whey fats can slow down this process) as well as a financial impact to the processing plant by losing this component (fat) in the cheese.

This invention has employed the use of carbon dioxide when using DVI culture system to create carbonic acid to lower the starting pH and thus lower the in-process whey fats and mimic the pH acidification curves and final pH and moistures in the cheese. The initial testing was done by lowering the milk pH to 6.55 target using dry ice (solid carbon dioxide) during the milk fill step in the process. This is a 0.08 average reduction in the starting milk pH. Initial work was done on Monterey Jack and White and Colored Cheddar cheeses in a commercial setting.

The initial testing was done using 55,000 pound capacity horizontal agitated enclosed cheese vats. Milk is standardized with a protein concentrate obtained from ultrafiltration technology to a milk fat target of 5.0%, protein target of 4.45%, lactose target of 4.6%, and pH target of 6.63. Depending upon casein:fat ratio, total solids can range from 14.8-15.5%, thus milk equivalent in the vat is 68,000-75,000 pounds. Standardized milk is pasteurized at 165° F. for minimum of 16 seconds and cooled to vat set temperature of 88-90° F. and pumped into vat. Dry ice is added when vat fill reaches 6000-8000 lbs. Dry ice is added either via pellet form or chunks of 3″×3″ pieces and allowed to melt into the vat milk. Dry Ice is added at a rate of 15 lbs per 72,000 pounds milk equivalent. Color (if needed) and calcium chloride are added to the vat as well as frozen pellet DVI cultures which consist of either mesophilic strains or a mesophilic/thermophilic strain blend of frozen pellets. Usage rate is 2375 DCU (Danisco Culture Units—a commercial unit) per 75,000 pounds milk equivalent. Once the vat is full, the milk pH is measured. Diluted coagulant (FPC—Fermentation Produced Chymosin—or Marzyme Supreme microbial) is added via automated system to the vat and stirred in for 3-4 minutes, reversing agitators for 45 seconds to promote slowing of the milk mass, to achieve more even coagulation. Vat is allowed to coagulate and is cut at proper time when a spatula has made a clean slice of the cheese mass. Cheese mass is cut into ⅜″ cubes and allowed to heal for 1-5 minutes. Jacketed heat is applied to the vat and the cheese and whey temperature is brought up to 101-103° F. Once cooking is complete, the cheese and whey is transferred to an enclosed belt system to form a mat of cheese and drain the whey. The pump over pH is taken at this time as well as pump over pH of the curd and whey. In addition, the whey fat is measured. In the case of Monterey Jack (MJ), a warm water spray (86-88° F.) is put on the curd in this vessel to allow for reduction of the concentration of lactose to control moisture and pH of the final product. A sufficient amount of time is employed to mat the curd and drain the whey, then the cheese is automatically cut using a mill machine into approximately ¾-1″×4″ pieces of cheese curd. CM whey fat (cheese machine whey fat, also called whey fat before salt) is taken at this time as well as mill pH of curd and whey. These milled cheese pieces are transferred to a salting belt which applies 2 salting applications via automated system and then allows approximately 10 minutes of mellowing time. Salted curd is then transferred to a distributor which transfers the curds to towers which press the cheese curd together and vacuum out the whey to produce 40 lbs blocks of pressed cheese. These 40 lbs blocks are bagged, weighed, labelled and then sent to a pre-cooler which brings the temperature to near 50° F. Packaged blocks go from the pre-cooler to be palletized and onto racks in a 35 degree Fahrenheit cooler warehouse until shipment. Finished goods samples are run for moisture, fat, salt and pH at 5 days after make.

Results of the initial testing showed that by using dry ice (carbon dioxide) to lower the initial vat milk pH, the DVI cultures can more mimic the bulk starter culture system make resulting in final moistures and pHs which meet specification. In addition, the whey fats results when using DVI and employing the carbon dioxide technology can reduce the whey fats to levels seen with bulk starter. Further, Marzyme Supreme can have similar results as FPC when looking at whey fat retention in the curd and employing the carbon dioxide technology.

The following results were seen using carbon dioxide technology with DVI vs. bulk starter and Marzyme Supreme vs. FPC in commercial vats using the procedures outlined above:

| | | | Total | | | |
|---|---|---|---|---|---|---|
| | | | number | Milk | | CM Whey |
| Day | Type | DVI/BS | of Vats | pH | Whey Fat | Fat |
| 1 | MJ | CO2 + DVI + FPC | 5 | 6.538 | 0.184 | 0.46 |
| 1 | MJ | No CO2 + Bulk | 28 | 6.628 | 0.174 | 0.516 |
| | | Starter + FPC | | | | |
| 2 | WC | CO2 + DVI + | 5 | 6.57 | 0.22 | 0.50 |
| | | Marzyme Supreme | | | | |
| 2 | WC | No CO2 + Bulk Starter + | 20 | 6.643 | 0.196 | 0.514 |
| | | Marzyme Supreme | | | | |
| 4 | CC | CO2 + DVI + FPC | 36 | 6.59 | 0.208 | 0.44 |
| 5 | CC | CO2 + Bulk Starter + FPC | 35 | 6.58 | 0.18 | 0.387 |

Where MJ = Monterey Jack; WC = White Cheddar; CC = Colored Cheddar
CO₂ is 15lbs dry ice per 75,000 pounds milk equivalent
Where Whey Fat is measured during pump over of curd and whey to enclosed belt system, and CM Whey Fat is taken at milling of the cheese curd
Whey Fat and CM Whey Fat are expressed in % fat by weight values of the whey

Since final moistures and pHs are important for specification to the cheese processing plant, averages for days 4 and 5 were collected and analyzed for vats run with DVI vs. bulk starter. Specification for moisture cannot go above 39% for standard of identity of cheddar cheese, but of course there is an advantage to reach as near 39% because of final payment of cheese (price per pound final product). In addition, standard of identity for cheddar cheese for pH is below 5.35 pH, Commercial dairies target final pH between 5.05 and 5.20 for mild cheddar cheese. Final analysis is reflected below:

| | | | Total | Final | |
|---|---|---|---|---|---|
| | | | number | Moisture | Final |
| Day | Type | Vat treatment | of Vats | in % | pH |
| 4 | CC | CO2 + DVI + FPC | 36 | 37.64 | 5.131 |
| 5 | CC | CO2 + Bulk Starter + FPC | 35 | 37.72 | 5.094 |

Both DVI and Bulk Starter using the Carbon Dioxide technology were within specification and within the normal parameters of the commercial operations of this facility.

As benefits were seen with this addition of Carbon Dioxide with DVI culture systems and Marzyme Supreme, additional trials have been completed by dropping the starting milk pH to 6.40-6.45 pH. Findings have been a drop by over 50% in the amount of Marzyme Supreme needed for coagulation (75 weight oz. per 75,000 pound milk equivalents per vat drop to 35 weight oz. per 75,000 milk equivalents per vat); elimination of calcium chloride; decrease in CM whey fats; final moisture and pHs meeting specification targets; fines reduction of 25-30%, increasing final cheese yield.

Carbon dioxide was added via sparging unit to these test vats at a rate of 17 lbs per vat at about 50 pounds per square inch pressure. Milk equivalent to the vat was 74,500 pounds.

The following data is from days 9 and 10 reflecting these changes:

| | | | Total | | | |
|---|---|---|---|---|---|---|
| | | | number | | | CM Whey |
| Day | Type | Milk additions | of Vats | Milk pH | Whey Fat | Fat |
| 9 | MJ | CO2 + DVI + Marzyme | 13 | 6.411 | 0.259 | 0.442 |
| | | Supreme | | | | |
| 10 | WC | CO2 + DVI + Marzyme | 10 | 6.442 | 0.312 | 0.411 |
| | | Supreme | | | | |

Whey Fat and CM Whey Fat are expressed in % fat by weight values of the whey

Additional make information is as follows:

| | | | Total | | | | | |
|---|---|---|---|---|---|---|---|---|
| | | Milk | number | | | Mill | | Final |
| Day | Type | additions | of Vats | | PO pH | pH | Final pH | Moisture |
| 9 | MJ | CO2 + DVI + | 13 | Recorded | 6.109 | 5.538 | 5.189 | 42.17% |
| | | Marzyme Supreme | | Target | 6.1-.25 | 5.5-.6 | 5.15-.25 | 41-43% |
| 10 | WC | CO2 + DVI + | 10 | Recorded | 6.225 | 5.385 | 5.113 | 36.87% |
| | | Marzyme Supreme | | Target | 6.1-.25 | 5.4-.6 | 5.05-.20 | 36.5-39% |

All make parameters fall within commercial production targets, with production on day 10 the mill pH a little low, however final pH and moisture are within targets.

This invention employs the fact that by adding carbon dioxide to vat milk we can reduce the milk pH by conversion to carbonic acid in the system. Using Dry Ice on an experimental design can mimic usage and in-process parameters such as with a sparging unit. By addition of carbon dioxide, the DVI method of culture addition can mimic bulk starter for in-process make parameters and final pH and moisture specification. Marzyme Supreme can replace FPC as coagulant by reducing in-process whey fats, thus leaving more fat in the cheese as well as reducing the usage rate substantially.

Various modifications and variations of the present invention will be apparent to those skilled in the art without departing from the scope and spirit of the invention. Although the invention has been described in connection with specific preferred embodiments, it should be understood that the invention as claimed should not be unduly limited to such specific embodiments. Indeed, various modifications of the described modes for carrying out the invention which are obvious to those skilled in chemistry, biology or related fields are intended to be within the scope of the following claims.

1. A process for the preparation of a cheese, the process comprising the steps of
(i) providing milk;
(ii) acidifying the milk, wherein the milk is acidified with carbon dioxide to a pH of 6.2 to 6.6 when measured at a temperature of 29 to 38° C. to provide an acidified milk;
(iii) inoculating the acidified milk with a starter culture, wherein the inoculation is a direct vat inoculation, to provide an inoculated acidified milk and making the cheese therefrom;
wherein the inoculated acidified milk contains a coagulant, wherein the coagulant comprises at least a microbial protease coagulating agent.

2. A process according to claim 1, wherein the cheese is selected from semi-hard cheeses, continental cheeses, gouda cheese, edam cheese, masdam cheese, cheddar cheese, cottage cheese, pasta filata cheese, mozzarella cheese, pizza cheese, hard cheeses, parmesan cheese, swiss-type cheese, emmental-type cheese, soft cheeses, Tvarog cheese, and lactic curd.

3. A process according to claim 1, wherein the milk is pasteurised milk.

4. A process according to claim 1, wherein the milk is selected from cow milk, sheep milk and goat milk.

5. A process according claim 1, wherein the milk is selected from whole milk, reconstituted skim milk powder, skim milk, and semi-skim milk.

6. A process according to claim 1, wherein the milk is standardised, homogenised or standardised and homogenised.

7. A process according to claim 1, wherein the milk is acidified by the addition of solid carbon dioxide to the milk, by the bubbling of gaseous carbon dioxide through the milk or a combination thereof.

8. A process according to claim 1, wherein the milk is acidified with carbon dioxide to a pH of 6.3 to 6.6 when measured at a temperature of 29 to 38° C.

9. A process according to claim 1, wherein the milk is acidified with carbon dioxide to a pH of 6.4 to 6.6 when measured at a temperature of 29 to 38° C.

10. A process according to claim 1, wherein the milk is acidified with carbon dioxide to a pH of 6.4 to 6.57 when measured at a temperature of 29 to 38° C.

11. A process according to claim 1, wherein the milk is acidified with carbon dioxide to a pH of 6.41 to 6.57 when measured at a temperature of 29 to 38° C.

12. A process according to claim 1, wherein the milk is acidified with carbon dioxide to a pH of 6.41, 6.44 or 6.57 when measured at a temperature of 29 to 38° C.

13. A process according to claim 1, wherein the milk is acidified with carbon dioxide to a pH of 6.2 to 6.6 when measured at a temperature of 31 to 36° C.

14. A process according to claim 1, wherein the milk is acidified with carbon dioxide to a pH of 6.2 to 6.6 when measured at a temperature of 33 to 35° C.

15. A process according to claim 1, wherein the milk is acidified with carbon dioxide to a pH of 6.2 to 6.6 when measured at a temperature of 34° C.

16. A process according to claim 1, wherein the milk is acidified solely with carbon dioxide.

17. A process according to claim 1, wherein the milk is acidified in part with carbon dioxide and in part with at least a secondary acidifying agent.

18. A process according to claim 17, wherein the secondary acidifying agent is selected from a culture, such a lactic acid bacteria culture, an organic or inorganic acid, such as hydrochloric acid or citric acid, and combinations thereof.

19. A process according to claim 1, wherein the coagulant consists essentially of a microbial protease coagulating agent.

20. A process according to claim 1, wherein the coagulant comprises a microbial protease coagulating agent and a secondary coagulating agent.

21. A process according to claim 20, wherein the secondary coagulating agent is selected from animal-based coagulants, rennet, vegetable-based coagulants, Ficine, and Bromeline, microbial-based coagulants, fermented produced chymosin coagulant, and proteases obtained from Mucor miehei or Mucor pusillus or Cryphonectria parasitica.

22. A process according to claim 1, wherein the microbial protease coagulating agent is a single enzyme coagulating agent.

23. A process according to claim 1, wherein the microbial protease coagulating agent has k-casein cleaving activity.

24. A process according to claim 1, wherein the microbial protease coagulating agent predominantly has k-casein cleaving activity.

25. A process according to claim 1, wherein the microbial protease coagulating agent solely has k-casein cleaving activity.

26. A process according to claim 1, wherein the microbial protease coagulating agent is k-casein specific cleaving enzyme.

27. A process according to claim 1, wherein the microbial protease coagulating agent has pepsin activity.

28. A process according to claim 1, wherein the microbial protease coagulating agent predominantly has pepsin activity.

29. A process according to claim 1, wherein the microbial protease coagulating agent solely has pepsin activity.

30. A process according to claim 1, wherein the microbial protease coagulating agent is a pepsin.

31. A process according to claim 1, wherein the microbial protease coagulating agent has mucorpepsin (EC 3.4.23.23) activity.

32. A process according to claim 1, wherein the microbial protease coagulating agent predominantly has mucorpepsin (EC 3.4.23.23) activity.

33. A process according to claim 1, wherein the microbial protease coagulating agent solely has mucorpepsin (EC 3.4.23.23) activity.

34. A process according to claim 1, wherein the microbial protease coagulating agent is a mucorpepsin (EC 3.4.23.23).

35. A process according to claim 1, wherein the microbial protease coagulating agent is a single enzyme coagulating agent consisting of a mucorpepsin (EC 3.4.23.23) having k-casein specific cleaving activity.

36. A process according to claim 1, wherein the microbial protease coagulating agent is mucorpepsin (EC 3.4.23.23).

37. A process according to claim 1, wherein the microbial protease coagulating agent is solely mucorpepsin (EC 3.4.23.23) MARZYME®.

38. A process according to claim 1, further comprising the step of measuring the pH of the milk of step (i), and adding carbon dioxide to the milk in amount required to provide acidified milk having a pH of 6.2 to 6.6 when measured at a temperature of 29 to 38° C.

39. A process according to claim 38, wherein the amount of carbon dioxide added is 90 grams [0.2 lbs] of carbon dioxide per 1000 lbs of milk per 0.08 unit pH reduction.

40. A cheese made according to the process of claim 1.

41. (canceled)

42. (canceled)

43. (canceled)
